(19) United States
(12) Patent Application Publication
(10) Pub. No.: US 2010/0075091 A1
(43) Pub. Date: Mar. 25, 2010

(54) THREE DIMENSION ORNAMENTAL ARTICLE

(76) Inventor: SHIH-FENG LEE, Taipei County (TW)

Correspondence Address: LEONG C LEI, PMB # 1008, 1867 YGNACIO VALLEY ROAD, WALNUT CREEK, CA, 94598, US

(21) Appl. No.: 12/234,713

(22) Filed: Sep. 22, 2008

(51) Int. Cl. B32B 33/00

(52) U.S. Cl. 428/40.1

(57) ABSTRACT

A three-dimension ornamental article is disclosed. The member comprises a plasticizing layer coated onto a substrate, an electroplated layer covered the plasticizing layer and an adhesion layer, wherein the plasticizing layer is epoxy resins or plastics. The base paper is a patterned layer and the circumferential edge of the patterned layer has dotted scored lines, facilitating the peeling off of the ornamental article.

### TECHNICAL FIELD OF THE INVENTION

The present invention relates to a three-dimension ornamental article, which provides various shapes and colorful ornamental structure.

### DESCRIPTION OF THE PRIOR ART

Three dimension ornamental designs are welcomed and accepted by many people for the reason that the shape and patterns are attractive. However, the conventional ornamental designs can be easily become out of date because some design are monotonous. In other words, the design or the shape cannot be changed. Accordingly, it is an object of the present invention to provide a three dimension ornamental article which is colorful and of attractive shapes.

### SUMMARY OF THE INVENTION

Accordingly, it is an object of the present invention to provide a three-dimension ornamental article comprising: a substrate of various shapes formed from a stamped shape; a plasticizing layer coated onto the substrate; an electroplating layer covered the plasticizing layer; and a peeling-off paper for transplanting the plasticizing layer covered with the electroplate layer.

Yet another object of the present invention is to provide a three-dimension ornamental article comprising a substrate of various shapes formed from a stamped shape; a plasticizing layer coated onto the substrate; an electroplating layer coated onto the plasticizing layer; and a various colored patterned layer having a shape corresponding to the plasticizing layer and adhered onto a peeling-off paper, for transferring the plasticizing layer coated with the electroplated layer to the base paper of the patterned layer.

Still another object of the present invention is to provide the three-dimension ornamental article comprising a substrate of various shapes formed from a stamped shape; a plasticizing layer coated onto the substrate; a glitter layer of various shapes and colors corresponding to the plasticizing layer and adhered onto a peel-off paper, an electroplated layer covered the plasticizing layer for the plasticizing layer covered with the electroplated layer to be transferred to the base paper.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a flowchart showing the fabrication of the three-dimension article of the first preferred embodiment of the present invention.

FIG. 2 is a perspective exploded view of the three-dimension ornamental article of the first preferred embodiment of the present invention.

FIG. 3 is a sectional view of the three-dimension ornamental article of the first preferred embodiment of the present invention.

FIG. 4 is a flowchart showing the fabrication of the three-dimension article of the second preferred embodiment of the present invention.

FIG. 5 is a perspective exploded view of the three-dimension ornamental article of the second preferred embodiment of the present invention.

FIG. 6 is a perspective view of a second preferred embodiment of the present invention.

FIG. 7 is a sectional view of the three-dimension ornamental article of the second preferred embodiment of the present invention.

FIG. 8 is a perspective exploded view of the three-dimension ornamental article of the third preferred embodiment of the present invention.

### DETAILED DESCRIPTION OF THE PREFERRED EMBODIMENTS

Embodiments of the present invention are illustrated in detail as follows:

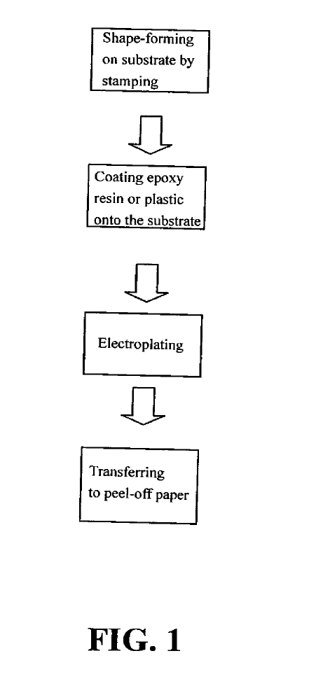

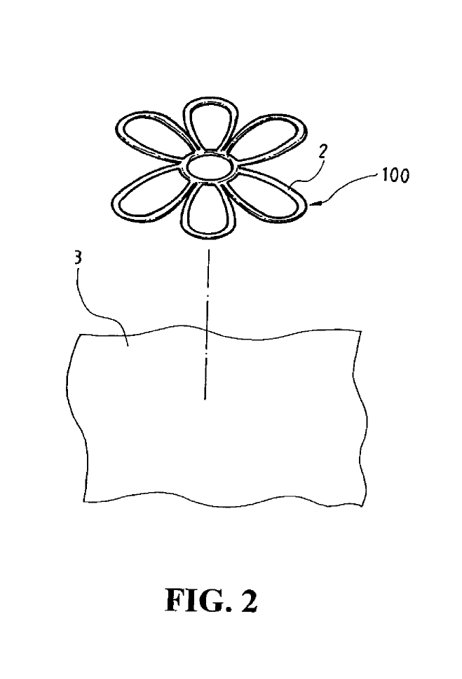

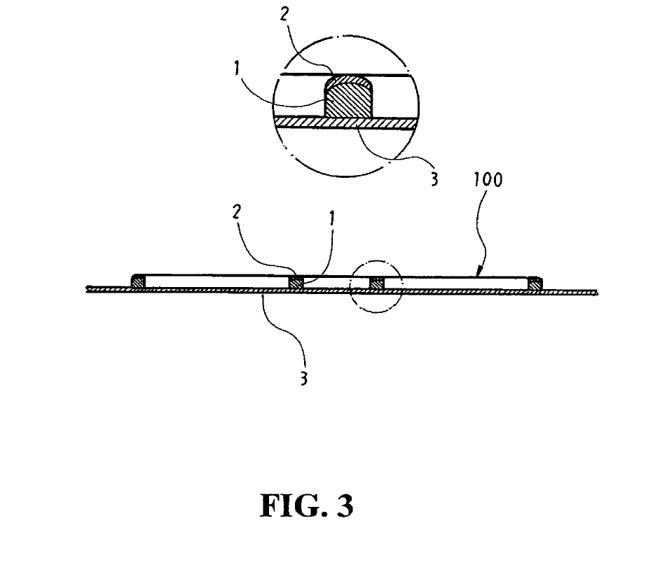

Referring to FIGS. 1, 2 and 3, there is shown a first preferred embodiment a plasticizing layer 1, an electroplating layer 2, and an adhesion layer which is a peel-off paper 3 forming into a striking and three dimension ornamental article 100. When application, the peel-off paper 3 is detached and the ornamental article is adhered to any object. In accordance with the present invention, the process of manufacturing the three dimension ornamental article comprises the steps of:
(1) forming, by stamping, on a substrate a plurality of shapes;
(2) coating onto various shapes of substrate an epoxy resin or plastics to form a plasticizing layer 1;
(3) covering an electroplating layer 2 onto the plasticizing layer 1; and
(4) transferring the plasticizing layer having covered with an electroplating layer 2 to a peel-off paper 3,

thereby, a three dimension ornamental article 100 is formed. The plasticizing layer 1 is light and has the advantage of being plasticized, different types of striking, ornamental article is obtained.

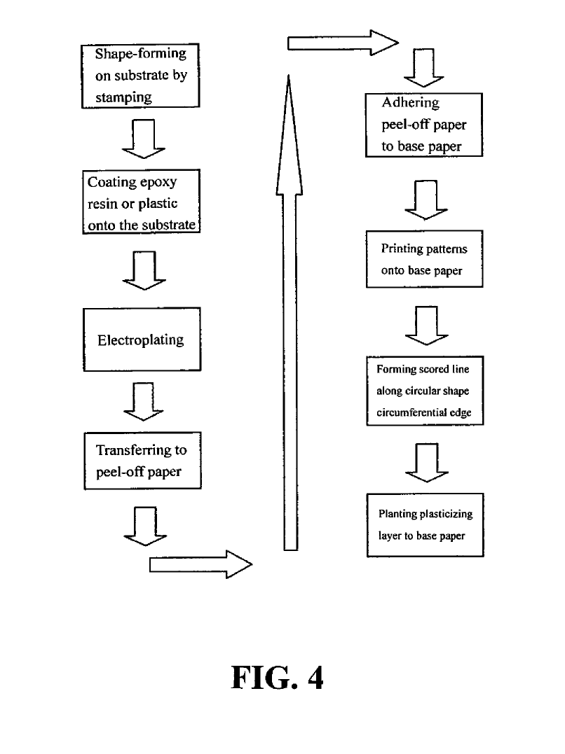

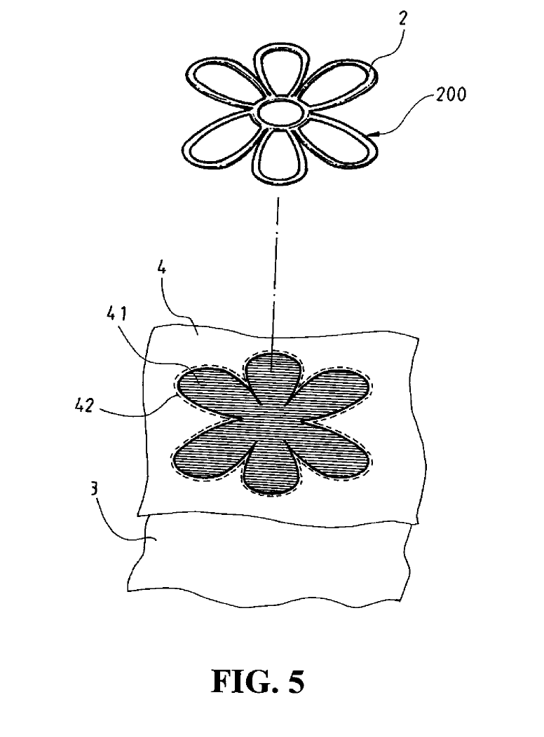

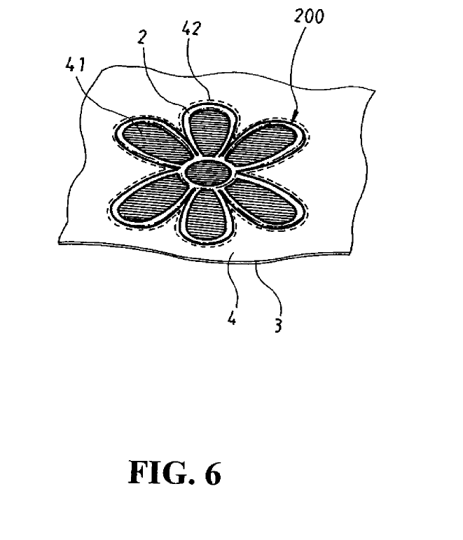

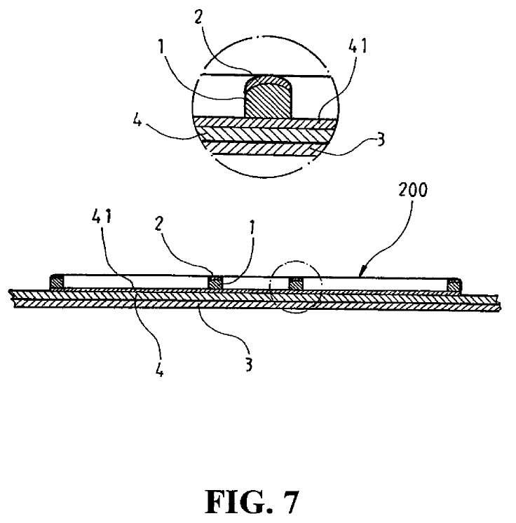

Referring to FIGS. 4, 5, 6 and 7, there is shown a second preferred embodiment comprising a plasticizing layer 1, an electroplating layer 2 and an adhesion layer which is a peel-off paper 3, and a base paper 4 adhered to the peel-off paper 4 to form into a striking, three dimension ornamental article 200. In accordance with the present preferred embodiment, the process of fabrication comprises the steps of
(1) forming, by stamping, on a substrate a plurality of shapes;
(2) coating onto various shapes of substrate an epoxy resin or plastics to form a plasticizing layer 1;
(3) covering an electroplating layer 2 onto the plasticizing layer 1; and
(4) adhering a peel-off paper 3 onto a base paper 4;
(5) printing different colors onto the base paper 4, wherein the base paper 4 together with the plasticizing layer 1 is corresponding to the corresponding shape of a patterned layer 41;
(6) forming scored dotted line 42 along the circumferential edge of the base paper 4 of the patterned layer 41; and
(7) transferring the plasticizing layer 1 having being covered with the electroplating layer 2 to the patterned layer 41 of the base paper 4 so as to form ornamental article 200 which has different colors and patterns. The ornamental article 200 possesses color variations and it can be peeled off along the dotted line 42. After the peel-off paper 3 is detached, the ornamental article 200 can be adhered to any object.

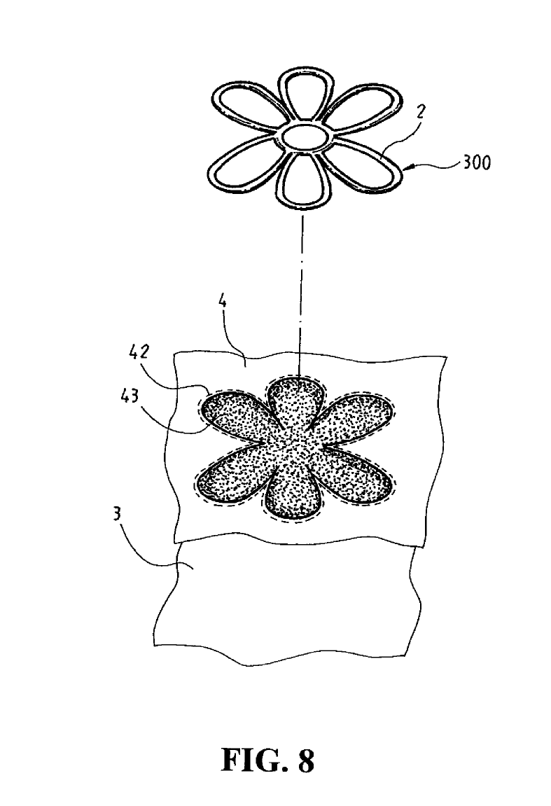

Referring to FIG. 8, there is shown a third preferred embodiment comprising a plasticizing layer 1, an electroplating layer 2, and an adhesion layer which is a peel-off paper 3, and a base paper 4 adhered onto the peel-off paper 3 to form into a three dimension ornamental object 300. The process of fabrication comprises
(1) forming, by stamping, on a substrate a plurality of shapes;
(2) coating onto various shapes of substrate an epoxy resin or plastics to form a plasticizing layer 1;
(3) covering an electroplating layer 2 onto the plasticizing layer 1; and
(4) adhering a peel-off paper 3 onto a base paper 4;
(5) providing different colors to the base paper 4 and together with the plasticizing layer corresponding to a glitter layer 43,
(6) forming scored dotted line 42 along the circumferential edge of the glitter layer 43 on the base paper 4;
(7) transferring the plasticizing layer 1 having being covered with the electroplating layer 2 to the patterned layer 41 of the base paper 4 so as to form ornamental article 300 which has different colors and patterns. The ornamental article 300 possesses color variations and it can be peeled off along the dotted line 42. After the peel-off paper 3 is detached, the ornamental article 300 can be adhered to any object.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A three-dimension ornamental article comprising:
a substrate of various shapes formed from a stamped shape;
a plasticizing layer coated onto the substrate;
an electroplating layer covered the plasticizing layer; and
a peeling-off paper for transplanting the plasticizing layer covered with the electroplate layer.

2. The three-dimension ornamental article of claim 1, wherein the plasticizing layer coated onto the substrate is epoxy resins or plastics.

3. A three-dimension ornamental article comprising
a substrate of various shapes formed from a stamped shape;
a plasticizing layer coated onto the substrate;
an electroplating layer coated onto the plasticizing layer; and
a various colored patterned layer having a shape corresponding to the plasticizing layer and adhered onto a peeling-off paper, for transferring the plasticizing layer coated with the electroplated layer to the base paper of the patterned layer.

4. The three-dimension ornamental article of claim 3, wherein the plasticizing layer coated onto the substrate is epoxy resins or plastics.

5. The three-dimension ornamental article of claim 3, wherein the circumferential edge of the patterned layer of the base paper is provided with scored lines.

6. The three-dimension ornamental article comprising
a substrate of various shapes formed from a stamped shape;
a plasticizing layer coated onto the substrate;
a glitter layer of various shapes and colors corresponding to the plasticizing layer and adhered onto a peel-off paper,
an electroplated layer covered the plasticizing layer for the plasticizing layer covered with the electroplated layer to be transferred to the base paper.

7. The three-dimension ornamental article of claim 6, wherein the plasticizing layer coated onto the substrate is epoxy resins or plastics.

8. The three-dimension ornamental article of claim 6, wherein the circumferential edge of the patterned layer of the base paper is provided with scored lines.
